(19) United States
(12) Patent Application Publication
(10) Pub. No.: US 2006/0260163 A1
(43) Pub. Date: Nov. 23, 2006

(54) Magnetic tracking system, method and device

(76) Inventors: Shelton E. Harrison JR., Culver CIty, CA (US); Scott Colby Hollifield, Santa Barbara, CA (US)

Correspondence Address: SHELTON E. HARRISON, JR., 6225 CANTERBURY DRIVE., UNIT 105, CULVER CITY, CA, 90230, US

(21) Appl. No.: 11/416,566

(22) Filed: May 3, 2006

Related U.S. Application Data
(60) Provisional application No. 60/678,877, filed on May 6, 2005.

(51) Int. Cl. G09F 7/04

(52) U.S. Cl. 40/600

(57) ABSTRACT

Disclosed is a means of tracking and communicating about events using refrigerator magnets. In a preferred embodiment, relationship health is tracked by moving foreground units appearing to be logs or bellows onto a background unit shaped like a fire. In an alternative embodiment, contents of a refrigerator are tracked by moving magnets symbolizing food items onto segments of a background magnet labeled “We Have” and “We Need.” In another alternative embodiment, food group symbols for dietary tracking are moved onto a background magnet of which the surface is partitioned according to a model diet of food group servings.

### CROSS-REFERENCE TO RELATED APPLICATIONS

Priority filing of U.S. provisional patent application 60/678,877, filing date of May 6, 2005, entitled “Magnetic Tracking System, Method and Device,” is claimed. Said provisional patent application is hereby incorporated by reference in its entirety into the present disclosure.

A portion of the disclosure of this patent document contains material which is subject to copyright protection. The copyright owner has no objection to the facsimile reproduction by anyone of the patent documents or patent disclosure, as it appears in the patent and trademark office patent file or records, but otherwise reserves all rights whatsoever.

### STATEMENT REGARDING FEDERALLY SPONSORED RESEARCH AND DEVELOPMENT

None.

### REFERENCE TO SEQUENCE LISTING, A TABLE OR A COMPUTER PROGRAM LISTING APPENDIX

None.

### BACKGROUND OF THE INVENTION

1. Field of the Invention

The invention relates to processes used to track events and also relates to games and refrigerator magnets.

2. Description of Related Art

Refrigerator magnets are popularly used both functionally, i.e., to hold items in place, and decoratively. Some refrigerator magnets, such as magnetic poetry, allow creative interaction between users.

The related art fails to disclose, however, refrigerator magnet systems that allow systematic means of communication between users and for tracking of certain activities.

What is needed, therefore, is a systematic means whereby couples can use refrigerator magnets to track the progress of their relationships; whereby users can track and communicate about the contents of a refrigerator; and whereby users, especially children, can track and communicate about their daily dietary habits.

### BRIEF SUMMARY OF THE INVENTION

Disclosed is a system, method and device whereby an individual, couple or family can track and communicate about the progress or health of a relationship or endeavor through the use of magnets.

A background unit is a flat sheet magnet suitable for magnetically clinging to a metallic surface, such as that of a refrigerator. The background unit may also include an adhesive backing for attachment to nonmetallic surfaces. Foreground units are flat sheet magnets, smaller than the background unit. Both foreground and background units may have special shapes and/or appearance features that cause them to visually resemble real-world objects, such as a fire log or a container of milk, which appearance facilitates the use of such magnets as symbols.

After, simultaneously with, or prior to the occurrence of an event, foreground units are moved by a user from one location to another location so as to cling either to (i) the background unit or (ii) a metallic surface to which the background unit is also attached or (iii) another foreground unit. The new location of the foreground unit with respect to the background unit indicates information intended to be symbolized, tracked or communicated by the user.

### BRIEF DESCRIPTION OF THE DRAWINGS

FIG. 1 is an anterior view of background and foreground units for use in a relationship tracking embodiment of the present invention.

FIG. 2A is an anterior view of background and foreground units for use in a relationship tracking embodiment of the present invention after one foreground unit has been moved.

FIGS. 2B through 2D depicted anterior close-up views of certain foreground magnets according to the present invention.

FIG. 3 is a flowchart depicting steps of a disclosed process in a relationship tracking embodiment of the present invention.

FIG. 4A is an anterior view of background and foreground units for use in a refrigerator contents tracking embodiment of the present invention.

FIG. 4B is a flowchart depicting steps of a disclosed process in a refrigerator contents tracking embodiment of the present invention.

FIG. 5 is an anterior view of background and foreground units for use in a food consumption tracking and dietary goal comparison embodiment of the present invention.

FIG. 6 is an anterior view of background and foreground units for use in a food consumption tracking and dietary goal comparison embodiment of the present invention after one foreground unit has been moved.

FIG. 7 is a flowchart depicting steps of a disclosed process in a food consumption tracking embodiment of the present invention.

### DETAILED DESCRIPTION OF THE INVENTION WITH REFERENCE TO THE DRAWINGS

### Relationship Tracking Embodiment

A preferred embodiment is that which has become commercially known as “Put Another Log on the Fire,” which product was recently awarded “Gift of the Year” honors from Reader's Digest magazine. This embodiment serves as a fun game as well as a means for communication between a couple through which they can track and commemorate the health and events of their romantic relationship.

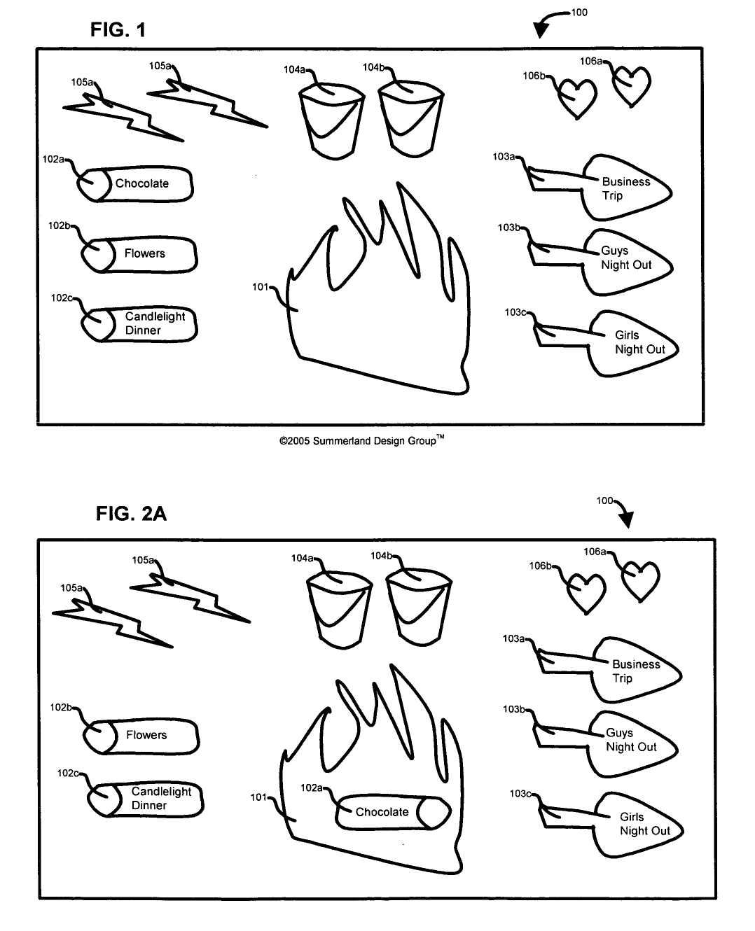

FIG. 1 depicts a metallic surface 100, which can be the surface of a refrigerator or can be a metallic sheet that is in turn attached to a nonmetallic surface so as to enable clinging of magnetic pieces. Also depicted are a magnet shaped to appear to be a fire 101, magnets that appear to be logs 102a-102c, magnets that appear to be bellows 103a-103c, magnets that appear to be buckets of water 104c-104b, magnets that appear to be lightning bolts 105a-105b, and heart-shaped magnets. 106a-106b.

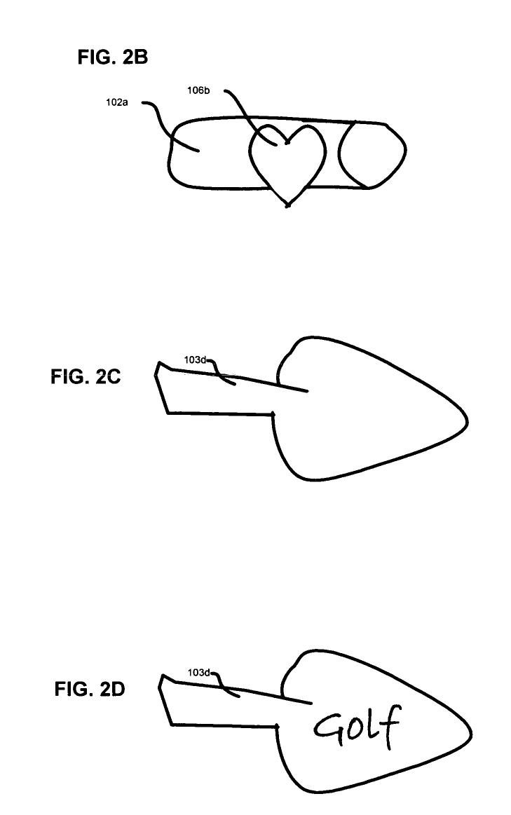

FIG. 2A depicts one of the log magnets 102a after it has been moved on top of the fire magnet 101 as per the process discussed below. FIG. 2B depicts one of the heart magnets 106b after it has been moved on top of one of the log magnets 102a as discussed below. FIG. 2C depicts a bellows magnet 103d that does not include a preprinted label, so that a user can write on this magnet 103d as shown in FIG. 2D, wherein a user has hand-written the word “Golf” onto the magnet 103d using an erasable magic marker.

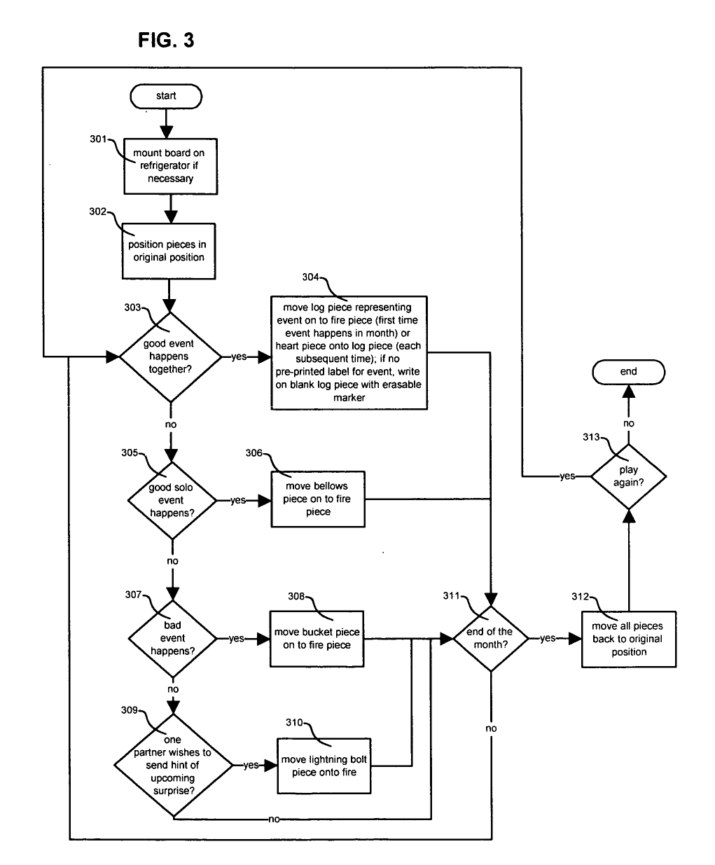

The magnets 101-106b depicted in FIG. 1 are used in a process disclosed in FIG. 3. If the exterior of a refrigerator to be used is nonmetallic, a user mounts 301 a metallic board 100 on the refrigerator. For the remainder of this discussion, it is assumed that a refrigerator with a metallic exterior is what the magnets are magnetically clinging to.

The various magnetic pieces 101-106b are then arranged 302 on the refrigerator 100 in original position, such that no foreground magnetic piece rests on top of the background piece 101.

Thereafter, when a couple experiences 303 good “together time”, such as when one member of the couple brings the other flowers or chocolates, this event is memorialized by moving 304 a log piece 102a onto the fire piece 101 as depicted in FIG. 2A. Each subsequent time the same type of event happens, a heart piece 106b is moved on to the corresponding log piece 102a as shown in FIG. 2B.

When one member of the couple experiences 305 good “away time”, such as a “girls' night out”, this event is memorialized by moving 306 a bellows piece 103c on to the fire piece. Some foreground pieces do not include pre-printed labels but rather are blank so that the a user can write upon the foreground piece 103d as per the example depicted in FIGS. 2C and 2D using an erasable magic marker. The inclusion of these blank magnets allows more flexibility and personalization of the game.

When a bad event happens 307, a bucket of water piece 104a is moved 308 onto the fire piece 101.

If one member of the couple simply wants to send a hint 309 to the other member about an upcoming surprise that is planned, a lightning bolt piece 105a is moved 310 onto the fire piece 101.

At the end of the month 311, all foreground 102a-106b pieces that have been placed onto the fire piece 101 during the month are moved 312 off of the fire piece and back to original position, as depicted in FIG. 1. If the couple wants to continue 313, the process begins again for the new month. Note that an alternate period of time, such as a day, a week, a year or another time period, can be used as the base time period for the game cycle.

### Refrigerator Contents Tracking Embodiment

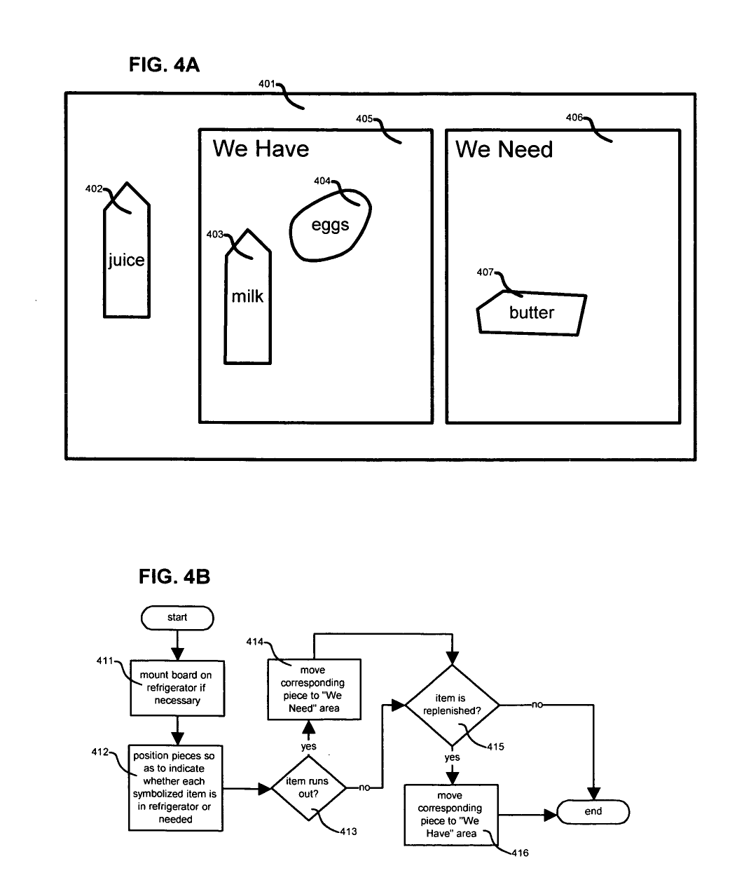

As shown in FIG. 4A, a background magnet 401 has a surface segment 405 labeled “We Have” and a separate surface segment 406 labeled “We Need”. Foreground magnets are shaped, colored and/or labeled so as to plainly symbolize various items that can be in a refrigerator, including a juice magnet 402, a milk magnet 403, an eggs magnet 404, and a butter magnet 407.

These magnets are used in a process disclosed in FIG. 4B. If necessary, a metallic surface is mounted 411 on a nonmetallic surface so as to enable the use of magnets, and the background magnet 401 is placed on the metallic surface. A user then takes inventory of the contents of a refrigerator and positions 412 magnet pieces so as to indicate visually what is on hand: magnets symbolizing things that are contained in the refrigerator (i.e., in stock, on hand) are placed in the “We Have” surface segment 405 of the background magnet 401, such as the milk magnet 403 and the eggs magnet 404 as shown in FIG. 4A, and magnets symbolizing things that are not contained in the refrigerator are placed in the “We Need” surface partiction 406, such as the butter magnet 407 as shown in FIG. 4A.

Thereafter, when an item that is in the “We Have” area 405 is exhausted 413, e.g., the user runs out of milk, the magnet symbolizing this item, e.g., the milk magnet 403 in FIG. 4A, is moved 414 from the “We Have” area 405 to the “We Need” area 406. When the item is replenished 415, the magnet symbolizing that item is moved 416 back to the “We Have” area 405.

In this way, a user can easily track items that he or she needs to buy during his or her next trip to be grocery store and can see what items are needed in a glance without looking in the refrigerator.

### Diet Tracking Embodiment

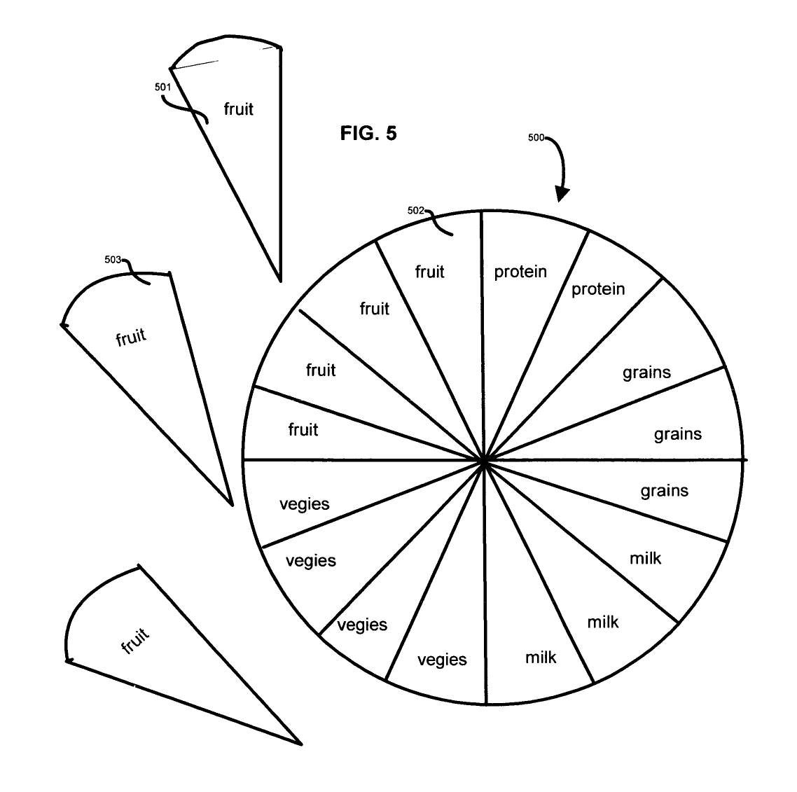

Another alternative embodiment is depicted in FIG. 5. A background unit 500 resembles a pie chart that is divided and labeled in accordance with the nutritional guidelines of a given diet, e.g., the FDA food pyramid, to which a user wishes to conform his or her conduct.

This dietary goal is embodied in the background unit by partitioning the surface into surface segments such that each slice of the pie chart represents one prescribed serving from a particular food group, such as fruit, vegetables, milk, grains, and protein (meat and beans, etc.). The result is that, for instance, if a diet prescribes exactly two servings from the protein group, exactly two surface partitions of the background unit are labeled “protein.”

Foreground units are manufactured in the shape of a piece of pie and in a size that fits in exactly one surface partition of the pie chart; each of these units is labeled with a particular food group e.g., “fruit”.

As shown in FIG. 5, a background magnet 500 has a surface that is divided into a number of surface segments 502, each of which is labeled with a particular food group; the type and quantity of food groups represented by surface segments of the background magnet 500 correspond to a diet to which a user aspires to conform his or her eating habits, e.g., recommended servings in an FDA-approved “food pyramid.” While the depicted embodiment uses a “pie” shaped background unit with pie-piece shaped foreground units, this shape is but an embodiment of the invention and not a limitation.

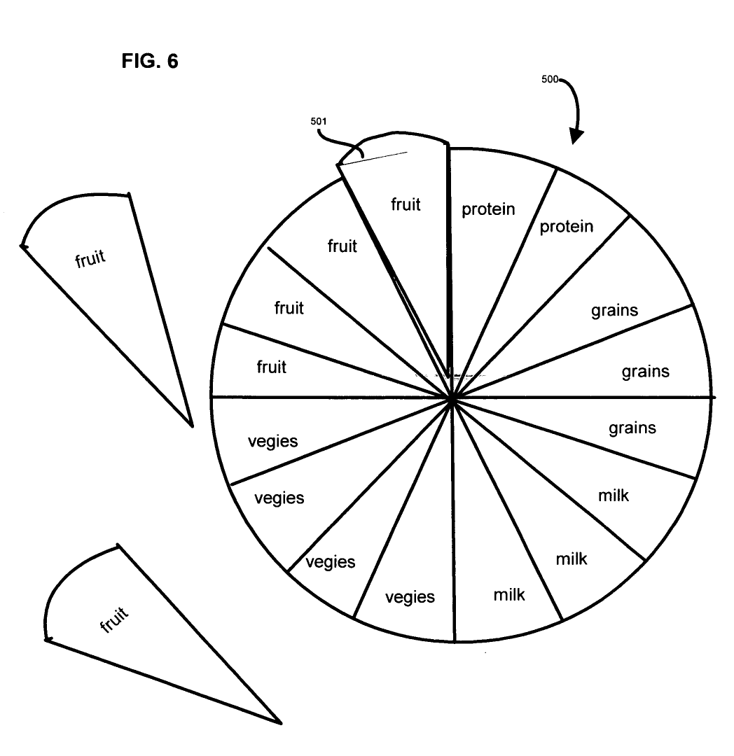

A foreground unit 501 can be moved onto the background unit 500 as depicted in FIG. 6 according to the process disclosed below.

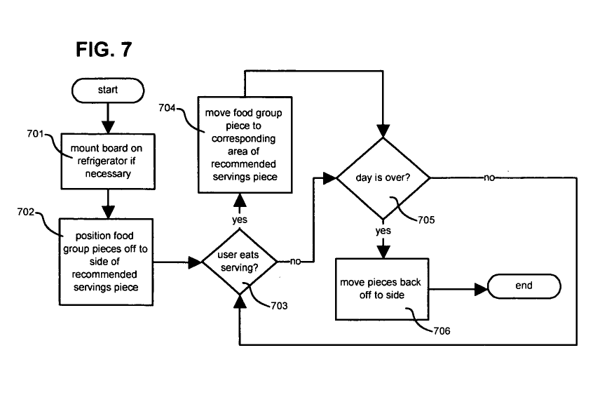

As disclosed in FIG. 7, at the beginning of a day, a user positions all foreground pieces 501 off to the side of the recommended servings piece 500, indicating that nothing has been eaten yet that day, as shown in FIG. 5.

Thereafter, a foreground unit 501 is moved 704 onto the surface partition 502 of the background unit 500 that corresponds to the type of food eaten by the user when a user eats a serving 703 of the food group symbolized by the foreground unit, e.g., fruit, vegetables, milk, grains, and protein (meat and beans, etc.). 501 as depicted in FIG. 6. When the day is over 705, all foreground pieces are moved 706 off to the side of the background piece and the process repeats.

By making the process of eating a good diet more enjoyable and providing immediate visual feedback regarding what and how much has been eaten and still needs to be eaten in a day, this embodiment facilitates the teaching of good nutritional habits to children.

Although the description above contains many specificities, these should not be construed as limiting the scope of the invention but as merely providing illustrations of some of the presently preferred embodiments of this invention. Accordingly, the scope of the invention should be determined by the appended claims and their legal equivalents, rather than by the examples given. For instance, as is plain to one skilled in the art, it will be understood that features of one embodiment may be combined with features of other embodiments while other features may be omitted or replaced as being nonessential to the practice of the invention, regardless of whether such combination, omission or modification has been explicitly described. As an example, it will be clear that different shapes, labels, and other visual indicia may be used without exceeding the scope of the present invention.

What is claimed is:

1. A method of communicating about one or more events, said method comprising the following steps:
positioning a first magnetic piece on a first metallic object so that said first magnetic piece clings to said first metallic object;
positioning a second magnetic piece in a first location; and
upon the occurrence of a first event pertaining to a first subject, moving said second magnetic piece to a second location, said second location being on said first magnetic piece.

2. The method in claim 1 wherein said first metallic object is a refrigerator.

3. The method in claim 1 wherein said first subject is a personal relationship.

4. The method in claim 1 wherein said first subject is an inventory of the contents of a refrigerator.

5. The method in claim 1 wherein said first subject is a diet.

6. The method in claim 1 wherein said first magnetic piece visually resembles a fire.

7. The method in claim 1 wherein said first magnetic piece comprises a first surface segment and a second surface segment, said first surface segment pertaining to items that are on hand and said second surface segment pertaining to items that are needed.

8. The method in claim 1 wherein said first magnetic piece comprises a plurality of surface segments, at least one of said surface segments pertaining to at least one food.

9. The method in claim 1 wherein said second magnetic piece visually resembles a log, a bellows, a bucket of water, a lightning bolt, or a heart.

10. The method in claim 1 further comprising the following step:
moving a third magnetic piece onto said second magnetic piece upon the occurrence of a second event.

11. The method in claim 10 wherein said second event is a re-occurrence of said first event.

12. The method in claim 1 further comprising the following step:
writing on said second magnetic piece.

13. The method in claim 1 wherein said first event is selected from the group consisting of (i) an experience a first plurality of people shares and (ii) an experience at least one member of said first plurality of people has without at least one other member of said first plurality of people.

14. The method in claim 1 wherein said first event is selected from the group consisting of (i) exhausting an item and (ii) restocking said item.

15. The method in claim 1 wherein said first event is selected from the group consisting of (i) ending of a day and (ii) ending of a month.

16. The method in claim 1 wherein said first event is consumption of a first food.

17. The method in claim 9 wherein the quantitative or qualitative composition of said plurality of surface segments is at least partly determined according to a recommended diet.

18. The method in claim 13 wherein said second magnetic piece differs from a third magnetic piece visually, said second magnetic piece symbolizing shared events and said third magnetic piece symbolizing events that are not shared.

19. The method in claim 18 wherein said plurality of people is a couple.

20. A method of communicating about one or more events, said method comprising the following steps:
positioning a first magnetic piece on a first metallic object so that said first magnetic piece clings to said first metallic object; and
prior to occurrence of a first event, moving a second magnetic piece from a first location to a second location wherein said moving serves to anticipate said first event and said second location is on said first magnetic piece.
